(19) United States
(12) Patent Application Publication
(10) Pub. No.: US 2022/0217939 A1
(43) Pub. Date: Jul. 14, 2022

(54) ANIMAL ENCLOSURE AND HABITAT WITH INTEGRAL NATURAL PLANT OR FORAGE PLATFORM

(71) Applicant: Mid-West Metal Products Company, Inc., Muncie, IN (US)

(72) Inventors: Brad Cantwell, Muncie, IN (US); Mark E. Watson, Farmland, IN (US); Michael E. Greene, Muncie, IN (US)

(21) Appl. No.: 17/573,990

(22) Filed: Jan. 12, 2022

Related U.S. Application Data
(60) Provisional application No. 63/136,780, filed on Jan. 13, 2021.

(51) Int. Cl. A01K 1/035; A01K 1/03

(52) U.S. Cl. CPC A01K 1/0356; A01K 1/03

(57) ABSTRACT

An animal enclosure assembly includes a top member, a bottom member, a front member, a rear member, a first side member, and a second side member. An interior is formed between the top member, the bottom member, the front member, the rear member, the first side member, and the second side member, where the interior is defined by at least a first level and a second level. A platform is located in the interior and coupled to at least one of the front member, rear member, first side member, and second side member. A ramp is coupled to the platform to allow travel to and from a location above, below or adjacent the platform. The platform includes a concave-shaped recess formed in the top surface.

### RELATED APPLICATIONS

This application claims the benefit of U.S. Provisional Patent Application Ser. No. 63/136,780, filed Jan. 13, 2021, the disclosure of which is hereby incorporated by reference in its entirety.

### FIELD OF THE DISCLOSURE

The present disclosure relates to an animal enclosure, and, in particular, to an animal enclosure including at least one platform.

### BACKGROUND

The use of animal cages or crate is well known. Many conventional cages have been developed over the years for housing animals of different shapes and sizes. For instance, animal cages typically house dogs and cats. Rabbits, hamsters, gerbils, mice, guinea pigs, and other small animals have also been known to be housed by such cages and are quite common. In fact, such cages are also used for farm animals when needed, including ducks and chickens. As cages have been further developed, the portability and ease of use have become points of emphasis. Some conventional cages, for example, have been designed to collapse to a compact structure for portability. Others have been designed to be of light weight and from durable materials. Conventional cages have been designed for ease of transporting an animal. Some conventional cages are designed as exercise pens that provide an interior space that the animal can move about, particularly outdoors.

### SUMMARY

In one embodiment of the present disclosure, an animal enclosure assembly includes a top member, a bottom member, a front member, a rear member, a first side member, and a second side member; an interior formed between the top member, the bottom member, the front member, the rear member, the first side member, and the second side member, the interior being defined by at least a first level and a second level; a platform located in the interior and coupled to at least one of the front member, rear member, first side member, and second side member, the platform including a top surface; and a ramp coupled to the platform to allow travel to and from a location above, below or adjacent the platform; wherein, the platform comprises a concave-shaped recess formed in the top surface.

In one aspect of this embodiment, the recess is filled with dirt and a natural plant. In a second aspect, the top surface is generally flat and surrounds the recess. In a third aspect, the platform is positioned in the first level closest to the bottom member. In a fourth aspect, at least one of the front member, rear member, first side member, and second side member comprises a semi-transparent or transparent material. In a fifth aspect, at least one of the front member, rear member, first side member, and second side member comprises a mesh material.

In another aspect, at least one of the front member, rear member, first side member, and second side member comprises a plurality of interconnecting horizontal and vertical wires. In a further aspect, the platform comprises a generally four-sided structure. In an alternative aspect, the platform comprises a generally L-shaped structure. In yet another aspect, the platform is positioned in the second level closest to the top member.

In a further aspect, a second platform is located in the interior and coupled to at least one of the front member, rear member, first side member, and second side member, wherein the ramp is coupled between the platform and the second platform. In yet a further aspect, the second platform comprises a concave-shaped recess formed in the top surface. Further, in a different aspect, the recess of the second platform is filled with dirt and a natural plant. In yet a further aspect, at least one tube port is formed in the front member, rear member, first side member or second side member.

In another embodiment of the present disclosure, an animal enclosure assembly includes a top member, a bottom member, a front member, a rear member, a first side member, and a second side member; an interior formed between the top member, the bottom member, the front member, the rear member, the first side member, and the second side member, the interior being defined by at least a first level and a second level; a first platform located in the interior and coupled to at least one of the front member, rear member, first side member, and second side member, the platform including a top surface; a second platform located in the interior and coupled to another of the front member, rear member, first side member, and second side member, the second platform including a top surface; a ramp coupled between the first platform and the second platform; wherein, the first platform comprises a first concave-shaped recess formed in the top surface thereof and the second platform comprises a second concave-shaped recess formed in the top surface thereof; wherein, the first platform is arranged within the interior at a different level than the second platform.

In one aspect of this embodiment, either the first recess or second recess is filled with dirt and a natural plant. In another aspect, the first platform is positioned in the first level closest to the bottom member and the second platform is positioned in the second level closest to the top member. In a further aspect, at least one tube port formed in the front member, rear member, first side member or second side member. In yet another aspect, at least one of the front member, rear member, first side member, and second side member comprises a semi-transparent or transparent material.

In a further embodiment of the present disclosure, a multi-animal enclosure assembly includes a first animal enclosure assembly and a second animal enclosure assembly, wherein the first animal enclosure assembly comprises at least one side member and a first tube port formed in the at least one side member; and the second animal enclosure assembly comprises a top member, a bottom member, a front member, a rear member, a first side member, and a second side member; an interior formed between the top member, the bottom member, the front member, the rear member, the first side member, and the second side member, the interior being defined by at least a first level and a second level; a platform located in the interior and coupled to at least one of the front member, rear member, first side member, and second side member, the platform including a top surface; a ramp coupled to the platform to allow travel to and from a location above, below or adjacent the platform; and a second tube port formed in the front member, rear member, first side member or second side member; wherein, the platform comprises a concave-shaped recess formed in the top surface; wherein, the first tube port and second tube port are aligned with one another such that a tube is coupled therebetween to provide access between an interior of the first animal enclosure and the interior of the second animal enclosure.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of an animal enclosure with a plurality of platforms;

FIG. 2 is a perspective view of another animal enclosure with a plurality of platforms;

FIG. 3 is a top schematic view of a platform with a recess defined therein;

FIG. 4 is a side schematic view of the platform of FIG. 3 with a natural plant or forage located in the recess;

FIG. 5 is a top schematic view of another platform with a recess defined therein;

FIG. 6 is a side schematic view of the platform of FIG. 5 with a natural plant or forage located in the recess;

Corresponding reference numerals are used to indicate corresponding parts throughout the several views.

### DETAILED DESCRIPTION

The embodiments of the present disclosure described herein are not intended to be exhaustive or to limit the disclosure to the precise forms disclosed in the following detailed description. Rather, the embodiments are chosen and described so that others skilled in the art appreciate and understand the principles and practices of the present disclosure.

The present disclosure relates to an animal enclosure. The animal enclosure can be used for multiple purposes, such as to contain one or more animals or objects. The enclosure can be made of any size for accommodating an animal or object of any size. In addition, the enclosure can be made of different materials including aluminum, plastic, and steel. The enclosure can be designed as an animal cage to define an interior that is surrounded at all sides, or it can be designed as an exercise pen in which at least one side is not present, for instance a top side.

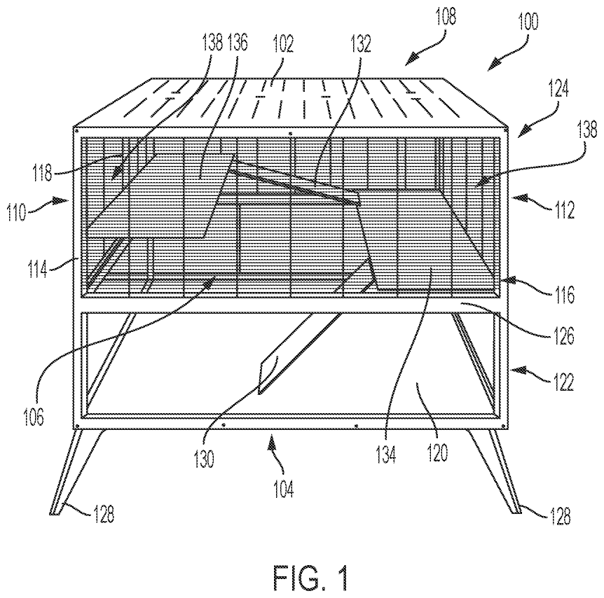

Referring to FIG. 1, an embodiment of an animal enclosure 100 is shown. The enclosure 100 is in the form of a small pet enclosure, but this is only intended to be exemplary. The enclosure 100 may include a top member 102, a bottom member 104, a front member 106, and a rear member 108. The front member 106 may include a door or gate assembly 116 which opens and closes to provide access to the interior of the enclosure 100. The enclosure 100 also includes a first side 110 and a second 112. A latch (not shown) may be operatively connected to the door assembly 116 and is configured to maintain the door assembly 116 in the closed position when latched. Other latching or locking mechanisms may be used for holding the door assembly 116 in a closed position.

While the door assembly 116 may be on the front of the enclosure 100, it is also possible for it to be integrated into either side member or rear member thereof. Moreover, the top member 102 may be removable in order to allow better access to the interior of the enclosure 100.

In some embodiments, the enclosure 100 may include a frame 114 which borders the different members. The frame 114 may be formed of a treated wood material, plastic, or other known material. The frame 114 may include a cross-member 126 that partially divides the enclosure 100 between a lower level 122 and an upper level 124. Upon removing the top member 102, a user may have direct access to the upper level 124.

The frame or border 114 may include slots or grooves (not shown) to which a member may be slidingly coupled. For example, the front member 106 may be coupled to the enclosure 100 by sliding it downwardly along slots or grooves formed in the frame or border 114. The cross-member 126 may include a slot (not shown) in which the front member 106 may pass through.

A portion of the enclosure 100 may include mesh and/or other portions may be transparent. In FIG. 1, the enclosure 100 is shown including the rear member 108 and portions of the first side member 110 and second side member 112 as comprising mesh material 118. The mesh material 118 may be screen-like material, or it may include a plurality of interconnecting horizontal and vertical wires. In any event, the mesh material 118 allows for sufficient ventilation of the interior of the enclosure 100.

The transparent portions 120 of the enclosure 110 may be formed as part of the front member 106 and the first side member 110 and/or second side member 112. In FIG. 1, for example, the front member 106 is entirely transparent, whereas a bottom portion of each of the first and second side members is transparent. The transparent material may be polycarbonate, for example, but it may comprise other known transparent, semi-transparent, or translucent material. Ideally, the transparent material allows a user or owner to visually see the interior of the enclosure 100 without the impediment of the mesh material 118 obstructing the view.

The bottom 104 of the enclosure 100 may be removable therefrom for ease in cleaning. Further, one or more legs 128 of a base structure may support the enclosure 100 on a ground or floor surface. The one or more legs 128 may be at least partly coupled to the bottom member 104.

The enclosure 100 of FIG. 1 is shown including a first platform 134 and a second platform 136. The first platform 134 is located between the lower level 122 and upper level 124, whereas the second platform 136 is located in the upper level 124. In other embodiments, the platforms may be located in the lower level, upper level, or therebetween. The platforms may be coupled to any one of the members that form the enclosure including the top member 102, front member 106, rear member 108, first side member 110, and second side member 112.

A first ramp 130 is shown leading between the bottom member 104 and the first platform 134. A second ramp 132 extends from the first platform 134 to the second platform 136. Thus, an animal such as a hamster, guinea pig, gerbil, or the like may easily traverse from the bottom member 104 to the second platform 136 via the ramps and first platform 134.

In the enclosure of FIG. 1, the first side member 110 and second side member 112 may include tube ports 138. The tube ports 138 may be fitted for a tube to be coupled thereto, thereby allowing an enclosed animal to travel between the enclosure 100 to another enclosure via the tube (not shown). Thus, one or more other enclosures may be coupled to the enclosure 100 of FIG. 1 by coupling one or more tubes to the tube ports 138.

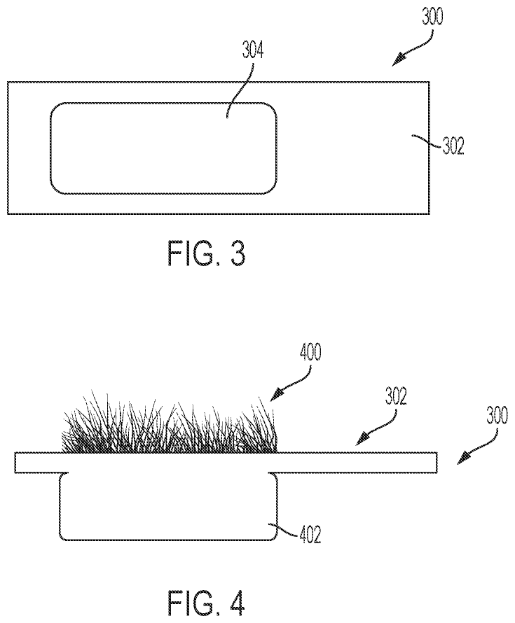

Referring to FIGS. 3 and 4, one embodiment of a platform 300 which may be coupled to the enclosure 100 of FIG. 1 is shown. The platform 300 may be either the first platform 134 or second platform 136. In any event, the platform 300 may include a top surface 302 that is substantially rectangularly-shaped. This, however, is only an example and is not intended to be limiting. The top surface 302 may have any desired shape.

The platform 300 may include a recess 304 defined in a portion of the top surface 302. The recess 304 may form a bowl or cup-like structure 402 as shown in FIG. 4. With this structure, a user or owner may deposit dirt or the like into the recess 304 for planting a natural plant 400 such as grass or forage. Alternatively, herbs, mint, bean sprouts, or any other natural plant may be planted in the recess 304. Any plant or food item may be grown in the recess. Further, the recess may simply be used for water from which the enclosed animal may drink or bathe, or for food from which the enclosed animal may eat. The use or function of the recess is unlimited, and any user or owner of the enclosure may use the recess for their desired purpose.

In one embodiment, at least one of the top member 102, front member 106, rear member 108, first side member 110, and second side member 112 may be formed of a transparent or sem-transparent material to allow sunlight, for example, to reach the natural plant 400 to help with growth. In another embodiment, one or more of these members may be formed of mesh material which may allow sunlight to penetrate through and reach the platform. In other embodiments, one or more of the members may be partially transparent or semi-transparent and partially mesh.

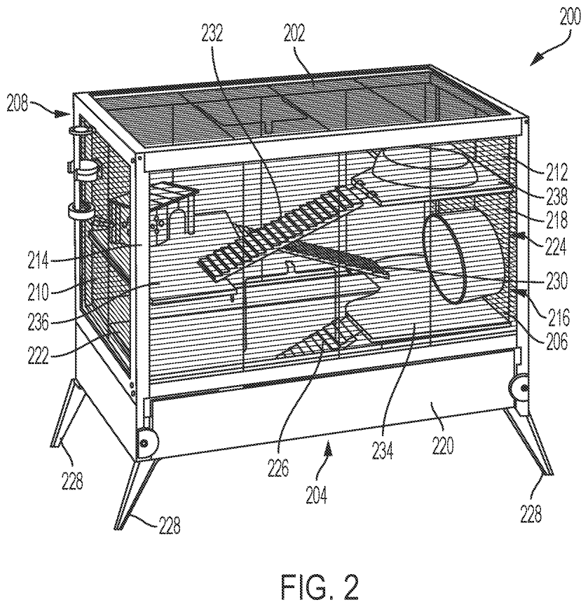

Turning now to FIG. 2, a different animal enclosure 200 is shown. The enclosure 200 may include a top member 202, a bottom member 204, a front member 206, and a rear member 208. The front member 206 may include a door or gate assembly 216 which opens and closes to provide access to the interior of the enclosure 200. The enclosure 200 also includes a first side 210 and a second 212. A latch (not shown) may be operatively connected to the door assembly 216 and is configured to maintain the door assembly 216 in the closed position when latched. Other latching or locking mechanisms may be used for holding the door assembly 216 in a closed position.

While the door assembly 216 may be on the front of the enclosure 200, it is also possible for it to be integrated into either side member or rear member thereof. Moreover, the top member 202 may be removable in order to allow better access to the interior of the enclosure 200.

In some embodiments, the enclosure 200 may include a frame 214 which borders the different members. The frame 214 may be formed of a treated wood material, plastic, or other known material.

The enclosure 200 may include a built-in drawer 220 that may pull out to allow a user access to a bottom portion or lower level 222 of the enclosure 200. The lower level 222 may include a pan (not shown), as known in the art. An area above the lower level 222 (i.e., above the drawer 220) may be referred to as an upper level 224.

The frame 214 may include a cross-member 126 that partially divides the enclosure 200 between a lower level 222 and an upper level 224. Upon removing the top member 202, a user may have direct access to the upper level 224.

The border 214 may include slots or grooves (not shown) to which a member may be slidingly coupled. For example, the front member 206 may be coupled to the enclosure 200 by sliding it downwardly along slots or grooves formed in the border 214.

A portion of the enclosure 200 may include mesh and other portions may be transparent. In FIG. 2, the enclosure 200 is shown including the rear member 208, top member 202, the first side member 210 and second side member 212 as including mesh material 218. The mesh material 218 may be screen-like material, or it may include a plurality of horizontal and vertical wires. In any event, the mesh material 218 allows for sufficient ventilation of the interior of the enclosure 200.

The transparent portions 120 of the enclosure 210 may be formed as part of the front member 206. In FIG. 2, for example, the front member 206 is entirely transparent. Other members of the enclosure 200 may also be transparent in another embodiment. The transparent material may be polycarbonate, for example, but it may comprise other known transparent, semi-transparent, or translucent material. Ideally, the transparent material allows a user or owner to visually see the interior of the enclosure 200 without the impediment of the mesh material 218 obstructing the view.

The bottom 204 of the enclosure 200 may be removable therefrom for ease in cleaning. Further, one or more legs 228 of a base structure may support the enclosure 200 on a ground or floor surface. The one or more legs 228 may be at least partly coupled to the bottom member 204.

The enclosure 200 of FIG. 1 is shown including a first platform 234, a second platform 236, and a third platform 238. The first platform 234 may be located between the lower level 222 and upper level 224, whereas the second platform 236 and third platform 238 may be located in the upper level 224. In other embodiments, the platforms may be located in the lower level, upper level, or therebetween.

A first ramp 226 is shown leading between the bottom member 204 and the first platform 234. A second ramp 230 extends from the first platform 234 to the second platform 236, and a third ramp 232 extends from the second platform 236 to the third platform 238. Thus, an animal such as a hamster, guinea pig, gerbil, or the like may easily traverse from the bottom member 204 to the third platform 238 via the ramps and intermediate platforms.

In the enclosure of FIG. 2, the first side member 210 and second side member 212 may include tube ports 138 similar to those described with reference to FIG. 1. Thus, one or more other enclosures may be coupled to the enclosure 200 of FIG. 2 by coupling one or more tubes to the tube ports 138.

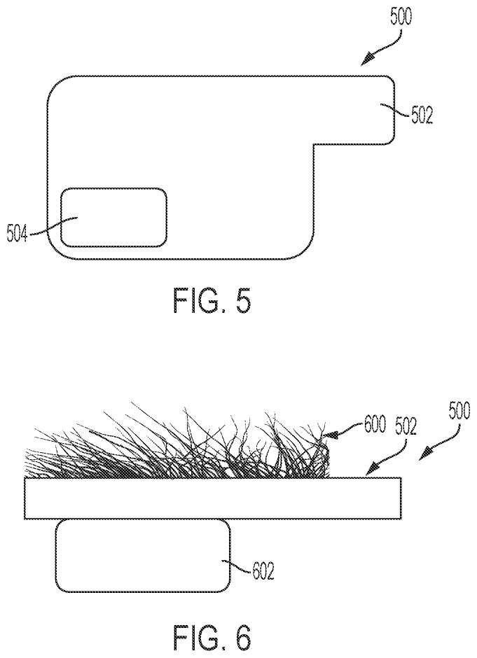

Referring to FIGS. 5 and 6, one embodiment of a platform 500 which may be coupled to the enclosure 200 of FIG. 1 is shown. The platform 500 may be either the first platform 234 or second platform 236. In any event, the platform 500 may include a top surface 502 that is shaped differently from the platform 300 of FIG. 3. This, however, is only an example and is not intended to be limiting. The top surface 502 may have any desired shape.

The platform 500 may include a recess 504 defined in a portion of the top surface 502. The recess 504 may form a concave (e.g., a bowl or cup-like) structure 602 as shown in FIG. 6. With this structure, a user or owner may deposit dirt or the like into the recess 504 for planting a natural plant 600 such as grass or forage. Alternatively, herbs, mint, bean sprouts, or any other natural plant may be planted in the recess 504. Any plant or food item may be grown in the recess. Further, the recess may simply be used for water from which the enclosed animal may drink or bathe, or for food from which the enclosed animal may eat. The use or function of the recess is unlimited, and any user or owner of the enclosure may use the recess for their desired purpose.

The aforementioned enclosures of FIGS. 1 and 2 therefore may include built-in natural grass foraging platforms as shown in FIGS. 3-6. In other embodiments, the enclosures may include running wheels, feeding bowls, water bottles, and other features. In one example of the enclosure 100 of FIG. 1, the front member 106 may comprise a top portion and a bottom portion separable by the cross-member 126. The top and/or bottom portion may include a drop down access panel to allow easy access to the upper or lower portions.

In another embodiment of the present disclosure, two or more animal enclosures may be provided to form an assembly such that each enclosure has one or more side members which form an interior. A tube port may be formed in a corresponding side member of each of the first and second enclosures. In order to allow an animal access between the interiors of both enclosures, a tube may be coupled to each tube port. The hollow tube may be accessed in each enclosure. Each animal enclosure may comprise the features of either FIG. 1 or 2, for example. Each enclosure may include a plurality of tube ports to permit access between multiple animal enclosures including three or more enclosures.

While exemplary embodiments incorporating the principles of the present disclosure have been disclosed herein, the present disclosure is not limited to the disclosed embodiments. Instead, this disclosure is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An animal enclosure assembly, comprising:
a top member, a bottom member, a front member, a rear member, a first side member, and a second side member;
an interior formed between the top member, the bottom member, the front member, the rear member, the first side member, and the second side member, the interior being defined by at least a first level and a second level;
a platform located in the interior and coupled to at least one of the front member, rear member, first side member, and second side member, the platform including a top surface; and
a ramp coupled to the platform to allow travel to and from a location above, below or adjacent the platform;
wherein, the platform comprises a concave-shaped recess formed in the top surface.

2. The animal enclosure assembly of claim 1, wherein the recess is filled with dirt and a natural plant.

3. The animal enclosure assembly of claim 1, wherein the top surface is generally flat and surrounds the recess.

4. The animal enclosure assembly of claim 1, wherein the platform is positioned in the first level closest to the bottom member.

5. The animal enclosure assembly of claim 1, wherein at least one of the front member, rear member, first side member, and second side member comprises a semi-transparent or transparent material.

6. The animal enclosure assembly of claim 1, wherein at least one of the front member, rear member, first side member, and second side member comprises a mesh material.

7. The animal enclosure assembly of claim 1, wherein at least one of the front member, rear member, first side member, and second side member comprises a plurality of interconnecting horizontal and vertical wires.

8. The animal enclosure assembly of claim 1, wherein the platform comprises a generally four-sided structure.

9. The animal enclosure assembly of claim 1, wherein the platform comprises a generally L-shaped structure.

10. The animal enclosure assembly of claim 1, wherein the platform is positioned in the second level closest to the top member.

11. The animal enclosure assembly of claim 1, further comprising a second platform located in the interior and coupled to at least one of the front member, rear member, first side member, and second side member, wherein the ramp is coupled between the platform and the second platform.

12. The animal enclosure of claim 11, wherein the second platform comprises a concave-shaped recess formed in the top surface.

13. The animal enclosure of claim 12, wherein the recess of the second platform is filled with dirt and a natural plant.

14. The animal enclosure assembly of claim 1, further comprising at least one tube port formed in the front member, rear member, first side member or second side member.

15. An animal enclosure assembly, comprising:
a top member, a bottom member, a front member, a rear member, a first side member, and a second side member;
an interior formed between the top member, the bottom member, the front member, the rear member, the first side member, and the second side member, the interior being defined by at least a first level and a second level;
a first platform located in the interior and coupled to at least one of the front member, rear member, first side member, and second side member, the platform including a top surface;
a second platform located in the interior and coupled to another of the front member, rear member, first side member, and second side member, the second platform including a top surface;
a ramp coupled between the first platform and the second platform;
wherein, the first platform comprises a first concave-shaped recess formed in the top surface thereof and the second platform comprises a second concave-shaped recess formed in the top surface thereof;
wherein, the first platform is arranged within the interior at a different level than the second platform.

16. The animal enclosure assembly of claim 15, wherein either the first recess or second recess is filled with dirt and a natural plant.

17. The animal enclosure assembly of claim 16, wherein the first platform is positioned in the first level closest to the bottom member and the second platform is positioned in the second level closest to the top member.

18. The animal enclosure assembly of claim 15, further comprising at least one tube port formed in the front member, rear member, first side member or second side member.

19. The animal enclosure assembly of claim 15, wherein at least one of the front member, rear member, first side member, and second side member comprises a semi-transparent or transparent material.

20. An multi-animal enclosure assembly, comprising:
a first animal enclosure assembly and a second animal enclosure assembly, wherein the first animal enclosure assembly comprises at least one side member and a first tube port formed in the at least one side member; and
the second animal enclosure assembly comprises:
a top member, a bottom member, a front member, a rear member, a first side member, and a second side member;
an interior formed between the top member, the bottom member, the front member, the rear member, the first side member, and the second side member, the interior being defined by at least a first level and a second level;
a platform located in the interior and coupled to at least one of the front member, rear member, first side member, and second side member, the platform including a top surface;
a ramp coupled to the platform to allow travel to and from a location above, below or adjacent the platform; and
a second tube port formed in the front member, rear member, first side member or second side member;
wherein, the platform comprises a concave-shaped recess formed in the top surface;
wherein, the first tube port and second tube port are aligned with one another such that a tube is coupled therebetween to provide access between an interior of the first animal enclosure and the interior of the second animal enclosure.
